(19) United States
(12) Patent Application Publication
(10) Pub. No.: US 2004/0078669 A1
(43) Pub. Date: Apr. 22, 2004

(54) Method for eliminating an error in a data processing unit

(76) Inventors: Jurgen Lang, Bergisch Gladbach (DE); Bernd Meyer, Konigswinter (DE)

Correspondence Address: CONNOLLY BOVE LODGE & HUTZ, LLP, P O BOX 2207, WILMINGTON, DE, 19899, US

(21) Appl. No.: 10/258,229

(22) PCT Filed: Apr. 24, 2001
(86) PCT No.: PCT/DE01/01553

(30) Foreign Application Priority Data
Apr. 27, 2000 (DE) 100205623

(51) Int. Cl. G06F 11/00

(52) U.S. Cl. 714/27

(57) ABSTRACT

The invention is characterized in that the data processing unit detects the error and then sends a first coded message to a central data processing facility. The central data processing facility decodes the signal and evaluates information on the error contained in the first message. Depending on the result of said evaluation, the central data processing facility then generates and/or selects an error elimination routine. The central data processing facility issues a program instruction that can be executed by the data processing unit. The program instruction is then coded by the data processing facility and sent to the data processing element as part of a second message.

The invention relates to a method for correcting an error that occurs in a data processing unit.

It is known that errors that occur in a data processing unit can be corrected by remote maintenance. In the known processes for remote maintenance, a central data processing system is given authorization to access the data processing unit and to subsequently repair this data processing unit by changing certain parameters.

The invention is based on the objective of carrying out a method of the generic type in such a way that a manipulation of the data processing unit by unauthorized persons is ruled out to the greatest extent possible.

According to the invention, this objective is achieved in that the data processing unit detects the error and subsequently transmits a first encrypted message to a central data processing system, in that the central data processing system decrypts the signal, in that the central data processing system evaluates the information about the error contained in the first message and, depending on the result of this evaluation, generates and/or selects an error correction routine, and in that the central data processing system issues a program instruction that can be executed by the data processing unit, and in that the program instruction is then encrypted by the data processing system and transmitted to the data processing unit as part of a second message.

In the present case, the term data processing unit is used in the broadest sense of the word. It encompasses all devices suitable for processing data, for example, computers or electronic circuitry. The data processing unit can likewise be a component of another device, for example, of a franking machine or of any other machine.

A further enhancement of the security of the method can be achieved in that, by examining the second message, the data processing unit verifies whether this message comes from the central data processing system.

In order to accelerate the method, it is advantageous for the data processing unit to receive the encrypted second message and to execute the program instruction contained therein.

Additional advantages, special features and practical refinements of the invention ensue from the subordinate claims and from the presentation of preferred embodiments below.

In the presentation below, the data processing unit is explained with reference to the example of a security module. The security module can be part of a computer that is located at the premises of the final users or that can be accessed via suitable data lines.

FIPS PUB 140-1 and from the derived test requirements (“Derived Test Requirements for FIPS PUB 140-1, Security Requirements for Cryptographic Modules”) describe requirements made of a total of eleven areas that have to be fulfilled to the proper extent or in the proper form, as a function of the level of the required security class. These are:

Design and Documentation of the Cryptographic Module

No deviations from the requirements according to FIPS PUB 140-1 and from the derived test requirements (“Derived Test Requirements for FIPS PUB 140-1, Security Requirements for Cryptographic Modules”).

Interfaces of the Module

No deviations from the requirements according to FIPS PUB 140-1 and from the derived test requirements (“Derived Test Requirements for FIPS PUB 140-1, Security Requirements for Cryptographic Modules”).

Utilization Profiles (“Roles”) and Utilization Options (“Services”)

In particular, exactly three utilization options (“services”), or utilization profiles (“roles”) are supported:

Users of the Customer System or the Customer System

Credit Amount Operator

The credit amount operator communicates with the security module within the scope of loading a credit amount and while deactivating the security module.

Customer System Operator

The customer system operator is a user who is legitimized by the customer system producer and who communicates with the security module for purposes of key administration and for maintenance purposes.

Model of the Finite States (“Finite State Machine Model”)

No deviations from the requirements according to FIPS PUB 140-1 and from the derived test requirements (“Derived Test Requirements for FIPS PUB 140-1, Security Requirements for Cryptographic Modules”).

Physical Security

No deviations from the requirements according to FIPS PUB 140-1 and from the derived test requirements (“Derived Test Requirements for FIPS PUB 140-1, Security Requirements for Cryptographic Modules”).

Security of the Software

No deviations from the requirements according to FIPS PUB 140-1 and from the derived test requirements (“Derived Test Requirements for FIPS PUB 140-1, Security Requirements for Cryptographic Modules”).

Security of the Operating System

No deviations from the requirements according to FIPS PUB 140-1 and from the derived test requirements (“Derived Test Requirements for FIPS PUB 140-1, Security Requirements for Cryptographic Modules”).

Administration of the Cryptographic Keys

In particular, no manually issued keys but rather exclusively electronically issued keys may be entered into the security module.

Cryptographic Algorithms

In the first version, the asymmetrical encryption according to RSA and the digital signature according to DSS are used. In later versions, additional cryptographic processes can follow. Otherwise, no deviations from the requirements according to FIPS PUB 140-1 and from the derived test requirements exist (“Derived Test Requirements for FIPS PUB 140-1, Security Requirements for Cryptographic Modules”).

No deviations from the requirements according to FIPS PUB 140-1 and from the derived test requirements exist (“Derived Test Requirements for FIPS PUB 140-1, Security Requirements for Cryptographic Modules”).

It is especially advantageous for the system to fulfill requirements that go beyond FIPS PUB 140-1.

In order to activate the security module from the customer system, the former is requested to submit its signed license (including its public key P_{SB}) as well as a random number X_{AUTH} having a length, for example, of 16 bytes, to the customer system. (The random number serves especially to secure against replay attacks if there is a non-secure transmission path between the keyboard of the customer system and the security module, for example, in the case of Internet solutions with a central security module server in the Internet and decentralized PCs as input terminals for log-in information such as, for instance, a PIN).

Error Handling:

If the signed license and the random number are requested several times, for example, three times consecutively, without log-in data from the customer system being subsequently transmitted to the security module, then this occurrence has to be recorded in the journal of the security module. In this status, exclusively a subsequent connection with the authentication station for purposes of error correction with transmission of the journal status is permissible, but not the production of forgery-proof documents such as event admittance tickets or postage indicia. The random numbers generated for further requests in this status have to match the numbers indicated in the third request (that is to say, no new generation of random numbers after the third attempt) in order to prevent the random sequence generator of the security module from being run through multiple times by an automatism of a non-legitimized customer system. No two of the first three random numbers generated in this process may match the random numbers that are issued in the next 100 valid sign-on attempts.

In the customer system, the hash value H (log-in_{credit amount}, Xₐᵤₜₕ) is formed on the basis of the log-in_{credit amount} information of the security module (for example, PIN or user/password; at the discretion of the customer system producer), which theoretically has 2¹²⁸ variants, and from the issued random number Xₐᵤₜₕ. This hash value is encrypted with the public key of the security module p_{SB} to form H_{SB} (log-in_{credit amount}, Xₐᵤₜₕ) in order to be transmitted to the security module. (The encryption renders it more difficult to perform an exhaustive search (brute force attack) for the log-in_{credit amount} data by repeated hash value formation of the known random number Xₐᵤₜₕ with randomly selected log-in data until a match is found.)

Moreover, in a format to be specified by the customer system producer, the customer system transmits to the security module the credit amount to be loaded. The credit amount is encrypted with the public key P_{SB} issued by the security module in order to be decrypted in the security module with the appertaining private key S_{SB}.

In the security module, the encrypted hash value HSB (log-in_{credit amount}, Xₐᵤₜₕ) as well as the additional encrypted data is decrypted with the private key of the security module.

The occurring errors are preferably handled as follows:

The system is configured in such a way that decryption can only take place with temporal proximity to the previous request for the random number. Moreover, a verification of the match is carried out.

In the security module, the same method is employed to form a hash value H′ (log-in_{credit amount}, Xₐᵤₜₕ) on the basis of the log-in_{credit amount} data stored in the security module and on the basis of the temporarily stored random number Xₐᵤₜₕ, whereby said hash value H′ is checked for a match with the transmitted and decrypted hash value H (log-in_{credit amount}, Xₐᵤₜₕ). In case of a match and conclusive information on the credit amount request, the security module is considered to have been properly activated.

If there is no match, the customer system (or the customer) has to be informed of the failed sign-on. Failed sign-on attempts have to be recorded in the journal of the security module. After three failed sign-on attempts, exclusively a subsequent connection with the central data processing system for purposes of error correction with transmission of the journal status is permissible, but not the production of postage indicia, etc. After three failed sign-on attempts, the security module has to require a five-minute pause before further sign-on attempts.

Data Processing in the Security Module:

The security module checks whether the signed license of the security module P_{PB} drawn up by the central data processing system is valid. For this purpose, the certificate of the central data processing system is checked according to the German Signature Law (SigG) at the certification station, taking into account the attribute that identifies the natural person as the responsible person, in order to issue signed licenses for the security module.

Error Handling:

If it is not a valid certificate of the central data processing system or if it is not a valid signed license of the security module, then this occurrence has to be recorded in the journal of the security module (simulated central data processing system, or the like). In this status, exclusively a subsequent connection with the central data processing system for purposes of error correction with transmission of the journal status is permissible, but not the production of postage indicia, etc. The customer system has to inform the user about the termination of the communication with the remark that another communication attempt should be made by the customer at a later point in time.

The signed license of the security module (including P_{PB}) is temporarily stored until the completion or termination of the session.

In the security module, the signature Sig_{PB} (SK1_{SB}) of the encrypted session key is checked using the public key of the central data processing system P_{PB}.

Error Handling:

If the signature verification fails, then this occurrence has to be recorded in the journal of the security module (changes to the contents are possible on the transmission path). In this status, exclusively a subsequent connection with the central data processing system for purposes of error correction with transmission of the journal status is permissible, but not the production of postage indicia, etc. The customer system has to inform the user about the termination of the communication with the remark that another communication attempt should be made by the customer at a later point in time.

The security module decrypts the encrypted session key SK1_{SB} using the its own private key S_{SB}.

In the security module, a high-value random number X with a length of 16 bytes is generated.

The random number X is stored in the security module.

In the security module, a high-value random number is generated as a customer's session key named “Request Key” RK with a length of 16 bytes.

The request key RK is stored in the security module.

In the security module, the useful data of the communication (level of the desired credit amount; remaining value of the current credit amount, ascending register of all credit amounts; last identification number of the loading procedure) is combined to form a data record D1.

Second Transmission From the Security Module to the Central Data Processing System:

The security module sends the encrypted session key SK1_{SB}, the encrypted request key RK_{PB}, the encrypted random number X_{PB} and the encrypted data record D1_{PB} to an authentication station.

Furthermore, the security module transmits the digital signature Sig_{PB} (SK1_{PB}, RK_{PB}, X_{PB}, D1_{PB}) of the encrypted session key SK1_{PB}, of the encrypted request key RK_{PB}, of the encrypted random number X_{PB} and of the encrypted data record D1_{PB} to the authentication station.

Moreover, the customer system transmits the requested utilization journal or utilization profile as non-encrypted and signed data record D2 to the authentication station.

Error Handling:

The transmission of the data can be announced to the customer in the customer system with the request that, if there is no response, another communication attempt should be made by the customer at a later point in time.

Data Processing in the Security Module:

The digital signature Sig_{PB} (X_{DPAG}, VID_{DPAG}, VID_{SB}, RK_{SB} and SK2_{SB}) is verified in the security module using the signed license P_{PB} of the security module that is temporarily stored there.

Error Handling:

If the signature verification fails, then this occurrence has to be recorded in the journal of the security module (changes to the contents are possible on the transmission path). In this status, exclusively a subsequent connection with the central data processing system for purposes of error correction with transmission of the journal status is permissible, but not the production of postage indicia, etc. The customer system has to inform the user about the termination of the communication with the remark that another communication attempt should be made by the customer at a later point in time.

The security module uses its own private key S_{SB} to decrypt the identification number of the loading procedure VID, the request key RK′ and the second session key SK2.

The transmitted request key RK is compared to the received request key RK′.

Error handling:

If the comparison of the random numbers fails, then this occurrence has to be recorded in the journal of the security module. In this status, exclusively a subsequent connection with the central data processing system for purposes of error correction with transmission of the journal status is permissible, but not the production of postage indicia, etc. The customer system has to inform the user about the termination of the communication with the remark that another communication attempt should be made by the customer at a later point in time.

In the security module, the utilization option is opened of increasing the electronic purse (“credit amount operator”) according to roles/services, as set forth in FIPS PUB 140. The opening of the utilization option must exclusively take place in the context of this communication session (together with the current request key, session key and its signature). In particular, it must be ruled out that the user can receive the utilization option of the credit amount operator locally and without a network connection.

Error Handling:

If the sign-on of the credit amount operator fails, the customer system (or the customer) can be informed of this. Failed sign-on attempts have to be recorded in the journal of the security module. After a failed sign-on attempt, exclusively a subsequent connection with the central data processing system for purposes of error correction with transmission of the journal status is permissible, but not the production of postage indicia, etc. After a failed sign-on attempt, the security module has to require a five-minute pause before further sign-on attempts.

In addition to the random number X, the credit amount operator stores the identification number of the loading procedure VID, the symmetrically encrypted random number and the symmetrically encrypted identification number of the loading procedure in the security module in such a way that this information is retained until the next loading of a credit amount. In each case, the two last generations of this information are stored in the security module.

The credit amount operator increases the purse value up to the current credit amount using the identification number of the loading procedure.

The credit amount operator sets the validity of the credit amount at the current value using the identification number of the loading procedure.

The credit amount operator ends its utilization option and leaves the further utilization to the customer system/customer.

In the security module, a high-value random number is generated as a customer's session key named “Confirm Key” having a length of 16 bytes.

The confirm key CK is stored in the security module.

The security module encrypts the second session key SK2, the confirm key CK and the new or current identification number of the loading procedure VID (in order to confirm its receipt) using the public key of the security module P_{PB} to form SK2_{PB}, CK_{PB} and VID_{PB}.

The security module generates a digital signature Sig_{SB} (SK2_{PB}, CK_{PB} and VID_{PB}) of the encrypted session key SK2_{PB}, of the encrypted confirm key CK_{PB} and of the encrypted identification number of the loading procedure VID_{PB} using its own private key S_{PB}.

Third Transmission from the Security Module to the Central Data Processing System:

The security module transmits the encrypted second session key SK2_{PB}, the encrypted confirm key CK_{PB} and the encrypted identification number of the loading procedure VID_{PB} to the central data processing system.

Moreover, the security module transmits the digital signature Sig_{SB} (SK2_{PB}, CK_{PB} and VID_{PB}) of the encrypted second session key SK2_{PB}, of the encrypted confirm key CK_{PB} and of the encrypted identification number of the loading procedure VID_{PB} to the central data processing system.

Error Handling:

The transmission of the data can be announced to the customer in the customer system with the request that, if there is no response, another communication attempt should be made by the customer at a later point in time.

Status Query

The status query is purely a query of the value and of the validity of the current credit amount and it is a procedure that has be initiated by the customer or by the customer system.

Activation of the Security Module by the Customer/Basic System:

In order to activate the customer system from the security module, the latter is requested to transmit its public key P_{SB} as well as a random number X_{AUTH} having a length of 16 bytes to the customer system. (The random number serves especially to secure against replay attacks if there is a non-secure transmission path between the keyboard of the customer system and the security module, for example, in the case of Internet solutions with a central security module server in the Internet and decentralized PCs as input terminals for log-in information such as, for instance, a PIN).

Error Handling:

If the signed license and the random number are requested three times consecutively, without log-in data from the customer system being subsequently transmitted to the security module, then this occurrence has to be recorded in the journal of the security module. In this status, exclusively a subsequent connection with the central data processing unit for purposes of error correction with transmission of the journal status is permissible, but not the production of postage indicia, etc. The random numbers generated for further requests in this status have to match the numbers indicated in the third request (that is to say, no new generation of random numbers after the third attempt) in order to prevent the random sequence generator of the security module from being run through multiple times by an automatism of a non-legitimized customer system. No two of the first three random numbers generated in this process may match the random numbers that are issued in the next 100 valid sign-on attempts.

In the customer system, the hash value H (log-inₛₜₐₜᵤₛ, Xₐᵤₜₕ) is formed on the basis of the log-inₛₜₐₜᵤₛ information of the security module (for example, PIN or user/password; at the discretion of the customer system producer), which can theoretically have 2¹²⁸ variants, and from the issued random number Xₐᵤₜₕ. This hash value is encrypted with the public key of the security module p_{SB} to form H_{SB} (log-inₛₜₐₜᵤₛ, Xₐᵤₜₕ) in order to be transmitted to the security module. (The encryption renders it more difficult to perform an exhaustive search (brute force attack) for the log-inₛₜₐₜᵤₛ data by repeated hash value formation of the known random number Xₐᵤₜₕ with randomly selected log-in data until a match is found.)

In a format to be selected by the customer system, the customer system also transmits the request that a status query of the credit amount is to be made.

Data Processing in the Security Module:

In the security module, the encrypted hash value H_{SB} (log-inₛₜₐₜᵤₛ, Xₐᵤₜₕ) as well as the further encrypted data is decrypted with the private key of the security module.

Error Handling:

Decryption may only take place with temporal proximity to the previous request for the random number.

In the security module, the same method is employed to form a hash value H′ (log-inₛₜₐₜᵤₛ, Xₐᵤₜₕ) on the basis of the log-inₛₜₐₜᵤₛ data stored in the security module and on the basis of the temporarily stored random number Xₐᵤₜₕ, whereby said hash value H′ is checked for a match with the transmitted and decrypted hash value H (log-inₛₜₐₜᵤₛ, Xₐᵤₜₕ). In case of a match and conclusive information on the status query, the security module is considered to have been properly activated.

Error Handling:

If there is no match, the customer system (or the customer) has to be informed of the failed sign-on. Failed sign-on attempts have to be recorded in the journal of the security module. After three failed sign-on attempts, exclusively a subsequent connection with the central data processing system for purposes of error correction with transmission of the journal status (attribute TYPE=“help” in the <ACTION>-tag of POSTtalk) is permissible, but not the production of postage indicia, etc. After three failed sign-on attempts, the security module has to require a five-minute pause before further sign-on attempts.

After the authentication of the customer system/customer, the security module reads out the current identification number of the loading procedure, the previous identification number of the loading procedure, the current credit amount and the validity of the credit amount, and transmits them to the basic system. A change in these values by this user (FIPS PUB 140: role) in this utilization option (FIPS PUB 140: service) should not be possible.

1. A method for correcting an error that occurs in a data processing unit, whereby the data processing unit detects the error and subsequently transmits a message to a central data processing system, whereby the central data processing system evaluates the information about the error, whereby information is exchanged in encrypted form between the central data processing system and the data processing unit, characterized in that the central data processing system decrypts the signal, in that the central data processing system evaluates the information about the error contained in the first message and, depending on the result of this evaluation, generates and/or selects an error correction routine, and in that the central data processing system issues a program instruction that can be executed by the data processing unit and transmits it in encrypted form to the data processing unit.

2. The method according to claim 1, characterized in that, by examining the second message, the data processing unit verifies whether this message comes from the central data processing system.

3. The method according to one or both of claims 1 or 2, characterized in that the data processing unit receives the encrypted second message and executes the program instruction contained therein.
